(19) United States
(12) Patent Application Publication
(10) Pub. No.: US 2021/0212287 A1
(43) Pub. Date: Jul. 15, 2021

(54) HEATED ANIMAL WATER SUPPLY CONTAINER

(71) Applicant: Manna Pro Products, LLC, Chesterfield, MO (US)

(72) Inventor: Wei Wang, Wuxi City (CN)

(21) Appl. No.: 16/739,976

(22) Filed: Jan. 10, 2020

(51) Int. Cl. A01K 7/02; A01K 7/04

(52) U.S. Cl. CPC A01K 7/027; A01K 7/04; A01K 7/025

(57) ABSTRACT

Disclosed herein is a heated animal water supply container including a reservoir including an annular wall that defines a reservoir chamber and a basin coupled to the reservoir. The basing includes a base positioned beneath and coupled to the reservoir, an outer wall and, a heating system. The outer wall extends from the base, and the outer wall, the annular and the base define a trough configured to retain water. The base is planar between the outer wall and the annular wall. The heating system is coupled to the base and configured to transmit thermal energy to water within trough and reservoir chamber.

The present disclosure relates to animal water supply containers, and more particularly, to a water supply container that may be readily refilled and that heats the water contained within the animal water supply container.

### BACKGROUND

At least some known animal water supply containers include a reservoir for storing a quantity of water. Typically, the reservoir supplies water to an outer drinking trough surrounding the reservoir, which is accessible to the animal. At least some known animal water supply containers employ one or more mechanisms to control the flow of water from the reservoir to the drinking trough. For example, some known water supply containers utilize a passive gravity mechanism that draws water from inside the reservoir to fill the drinking trough. In some other known animal water supply containers, the mechanism may include an animal-actuated valve.

Animal water supply devices may be used outdoors or inside animal housings where there is limited control over the ambient temperature. For example, animal water supply containers may be placed in a chicken coop with minimal heating. When temperatures drop below freezing, water contained in the animal water supply container may form ice or completely freeze, restricting the flow of water from the reservoir into the drinking trough and inhibiting animal access to drinkable water.

Further, some known designs of animal water supply containers require tedious and sometimes challenging refilling methods. For example, some water supply containers require detaching the reservoir from the drinking trough. Then, the user must invert the reservoir such that the open end is upright, allowing the operator to fill the reservoir. While the reservoir is inverted, the drinking trough is reattached to the reservoir, and then the user must tip back over the whole, water filled container such that the drinking trough is upward orientated and the reservoir is downward-orientated.

Accordingly, it may be advantageous for animal water supply containers to control the temperature of the water and allow an operator to easily refill the reservoir.

### SUMMARY

One aspect of the present disclosure is directed an animal water supply container. The animal water supply container includes a reservoir and a basin. The reservoir includes an annular wall that defines a reservoir chamber. The basin is coupled to the reservoir and the basin includes a base, an outer wall, and a heating system. The base is positioned beneath and coupled to the reservoir. The outer wall extends from the base. The outer wall, the annular wall, and the base define a trough configured to retain water. The base is planar between the outer wall and the annular wall. The heating system is coupled to the base and configured to transmit thermal energy to water within trough and reservoir chamber.

Yet another aspect of the present disclosure is directed an animal water supply container, the water supply container includes reservoir. The reservoir includes an annular wall, a valve container, and a basin. The annular wall defines a reservoir chamber. The valve container defines a valve chamber. The valve chamber is coupled in flow communication with the reservoir chamber via an inlet defined in the valve container. The basin includes a base and an outer wall. The base is positioned beneath and coupled to the reservoir. The outer wall extends from the base. The outer wall extends from the base. The outer wall, the annular wall, and the base define a trough configured to retain water. The reservoir further comprises at least one passage extending between the valve container and the trough through the annular wall, wherein the passage couples the valve chamber in flow communication the trough.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of an example of a heated animal water supply container;

FIG. 2 is a cross-sectional view of the example heated animal water supply container shown in FIG. 1;

FIG. 3 is a perspective view of the cross-section of the example heated animal water supply container shown in FIGS. 1 and 2;

FIG. 4 is a perspective view of the base of the example heated animal water supply container shown in FIGS. 1 and 2; and

FIG. 5 is a schematic of an example control system for heating the water in the heated animal water supply container.

Corresponding reference characters indicate corresponding parts throughout the drawings.

### DETAILED DESCRIPTION

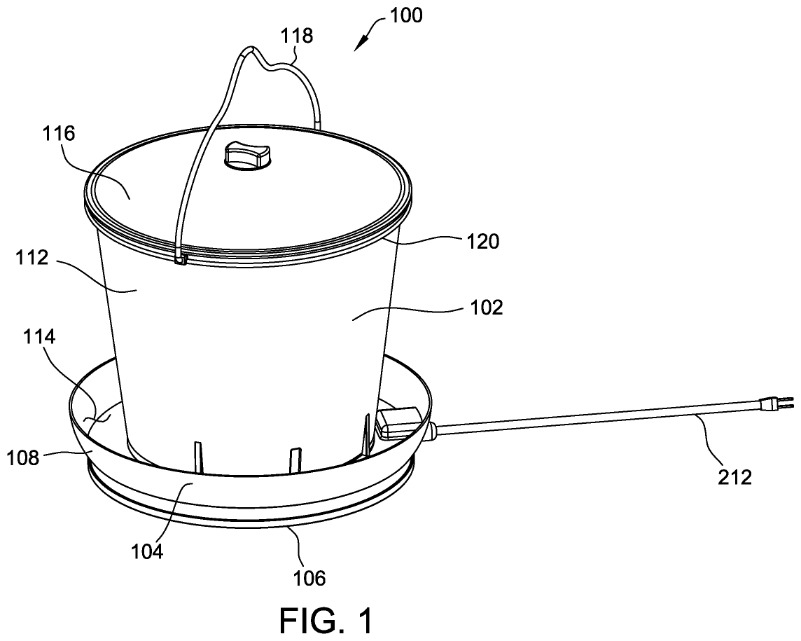

FIGS. 1-3 illustrate an example heated animal water supply container 100 according to example embodiments of the present disclosure. Supply container 100 includes a reservoir formed integrally with a basin. A buoyant float valve regulates the flow of liquid from within the reservoir through a valve chamber and into a drinking trough that provides drinking water to animals. A heating system is used to control the temperature of the water within the reservoir, the valve chamber, and the drinking trough.

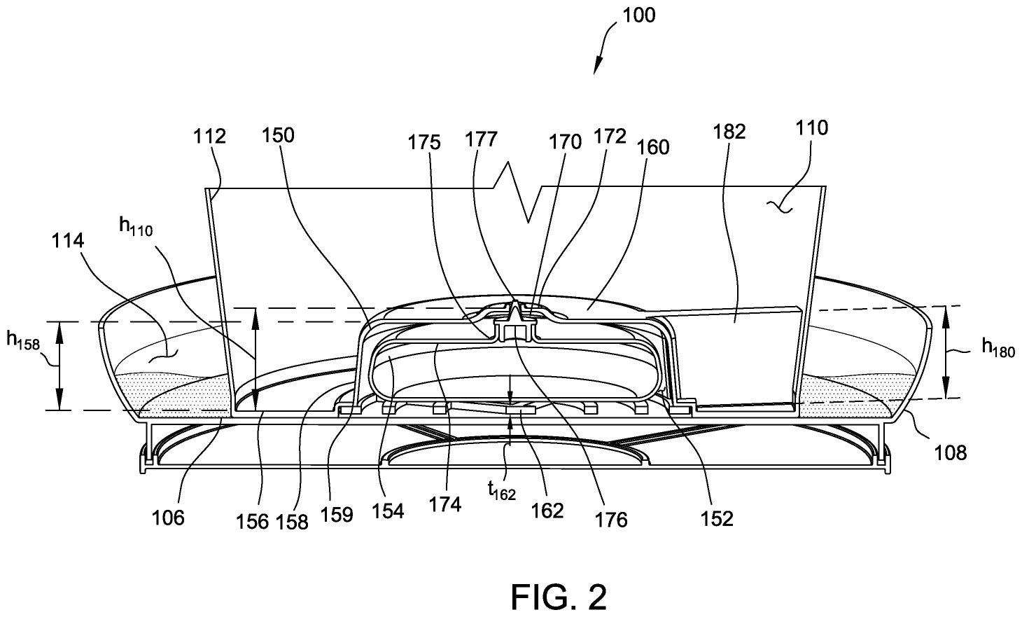

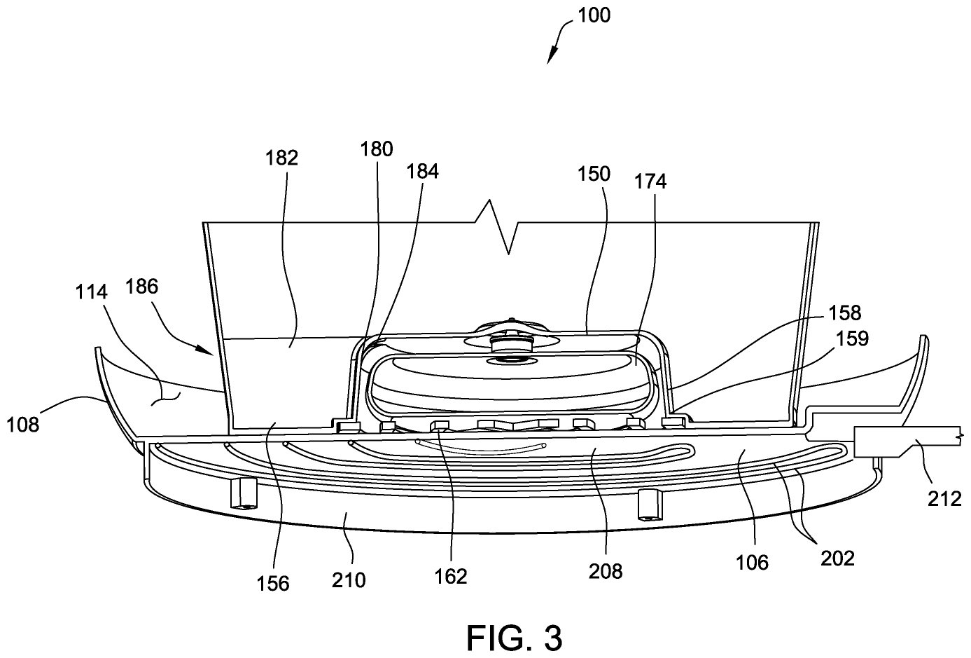

FIG. 1 is a perspective view of the water supply container 100 including a reservoir 102 and a basin 104. The basin 104 includes a base 106 and an outer wall 108 that extends upward from the base 106. The reservoir 102 includes a storage chamber 110 (shown in FIGS. 2 and 3) defined by an annular wall 112 that extends upward from the base 106 of the basin 104. The annular wall 112 is generally concentric with the outer wall 108 such that the annular wall 112 is spaced a distance inward of the outer wall 108 to define an annular drinking trough 114 therebetween. In some example embodiments, the reservoir 102 is removably coupled to the basin 104.

In embodiment illustrated in FIGS. 1-3, the reservoir 102 is bucket shaped and is sized to store enough water to fill the annular drinking trough 114. Alternatively, the reservoir 102 may be any shape to enable the storage chamber 110 to store enough liquid to fill the annular drinking trough 114. In embodiment shown in FIGS. 1-3, the reservoir 102 includes a top-fill reservoir.

A lid 116 may be removably coupled to the reservoir 102. The lid 116 may include a handle 118 and/or features that allow a user to easily remove and reattach the lid 116 to the reservoir 102. For example, the user may easily detach the lid 116 from the reservoir 102 in order to refill the storage chamber 110 through a top end 120 of the reservoir 102. In some example embodiments, the lid 116 and the top end 120 of the reservoir 102 may include threading features, such that lid 116 may be threaded on to the reservoir 102. In other example embodiments, the lid 116 may be press-fit onto the top end 120 of the reservoir 102.

The annular drinking trough 114 is formed by a portion of the outer wall 108, a portion of the base 106, and a portion 111 of the annular wall 112. In embodiment shown in FIGS. 1-3, the outer wall 108 and the portion of the annular wall 112 act as the side boundaries of the annular drinking trough 114. The base 106 is planar between annular wall 112 and outer wall 108 and acts as a lower boundary of the annular drinking trough 114. The lower boundary may account for a significant portion of the total boundary of the annular drinking trough 114. As a result, water contained within the annular drinking trough 114 is substantially in contact with the lower boundary defined by the base 106.

Referring to FIG. 2, the water supply container 100 further includes a valve container 150 positioned within the storage chamber 110 and spaced inwardly from the annular wall 112. The valve container 150 defines a valve chamber 152 housing a buoyant float valve 154. The valve chamber 152 is in flow-communication with the storage chamber 110. The reservoir 102 further includes an annular base 156 that may be formed integrally with the annular wall 112 and that extends the annular wall 112 parallel to the base 106 of the basin 104. In the embodiments shown in FIGS. 1-3, the annular base 156 is coupled to and contacts the base 106. In other example embodiments, the annular base 156 may be formed integrally with the base 106.

In the embodiments shown in FIGS. 1-3, the valve container 150 is formed integrally with the annular base 156. In alternative embodiments, the valve container 150 may be formed integrally with the base 106. In other alternative embodiments, the valve container may be coupled to at least one of the annular base 156 or base 106.

In embodiment shown in FIGS. 1-3, the valve container 150 is cylindrically-shaped and includes an annular wall 158 and a top portion 160. The annular wall 158 includes a lower edge 159 that extends upward from the base 106 or the annular base 156 to a height of h₁₅₈.

The valve container 150 further includes a base mesh 162 (also referred to herein as filter). The base mesh 162 is located in proximity to the base 106 of the basin 104 between the float valve 154 and the base 106. In operation, dirt and debris is deposited into the annular drinking trough 114 by the animals, and the base mesh 162 acts as a filter to reduce the amount of debris that flows into the valve chamber 152 from the annular drinking trough 114. In some example embodiments, the valve container 150 may not include a base mesh 162. As such, at least a portion of the base 106 may act as a lower boundary to the valve chamber 152.

The top portion 160 includes an inlet 170 defining the boundary of an opening between the storage chamber 110 and the valve chamber 152. In this illustrated embodiment, the inlet 170 is relatively centered on the top portion 160 and the inlet is circular in shape. The top portion 160 further includes a tapered extrusion 172 extending upward from the rest of the top portion 160 surrounding the inlet 170.

The inlet 170 allows a liquid to flow from within the storage chamber 110 and into the valve chamber 152 through the inlet 170. The buoyant float valve 154 is sized and shaped to fit within the valve container with a clearance volume to enable liquid flowing into the valve chamber 152 through the inlet 170 to fill the valve chamber 152 in the clearance volume surrounding the buoyant float valve 154. The buoyant float valve 154 may be sized, shaped, and, formed of a material that enables the the buoyant float valve 154 to float within the contents of the valve chamber 152, e.g., the buoyant float valve 154 may float in water contained in the valve chamber 152 In addition, the buoyant float valve 154 may be filled with substance that enables the buoyant float valve 154 to float. For example, the buoyant float valve 154 may be filled with air.

The buoyant float valve 154 is relatively cylindrical in shape and includes a top side 174. The top side 174 of the buoyant float valve 154 includes a stopper 176. The stopper 176 has tapered conical shape and extends upward from the rest of the top side 174. More specifically, the stopper 176 includes a proximal portion 175, arranged near the top side 174 and a distal portion 177 arranged distal the top side 174. The proximal portion 175 includes a diameter greater than a diameter of the distal portion 177. The buoyant float valve 154 is arranged within the valve chamber 152 to position the top side 174 in proximity to the top portion 160 of the valve container 150, and the stopper 176 is arranged on the top side 174 to dispose at least a portion of the stopper 176 within the inlet 170.

The tapered conical shape of the stopper 176 allows the stopper 176 to fit within the tapered extrusion 172 of the top portion 160 of the valve container 150. Further, the tapered conical shape of the stopper 176 may partially or fully block the inlet 170 to control the flow of liquid from the storage chamber 110 of the reservoir 102 into the valve chamber 152.

The buoyant float valve 154 moves to its lowest position when the valve chamber 152 is substantially empty, i.e., not filled with a liquid in the clearance area surrounding the buoyant float valve 154. At the lowest position, at least a portion of the stopper 176 is at least partially disposed within the inlet 170. The stopper 176 is sized and shape such, that in the lowest position, there is radial clearance between the stopper 176 and the inlet 170, allowing a liquid to pass from the storage chamber 110 of the reservoir 102 into valve chamber 152. For example, when the buoyant float valve 154 is in the lowest position, the distal portion 177 is disposed within the inlet 170. The diameter of the distal portion 177 is smaller than the diameter of the inlet 170 to form a clearance between the distal portion 177 of the stopper 176 and the inlet 170 allowing water to flow through this clearance into the valve chamber 152.

Additionally, the buoyant float valve 154 moves to its highest position when the valve chamber 152 is substantially filled, i.e. a liquid has filled at least a portion of the clearance area surrounding the buoyant float valve 154. At the highest point, a substantial portion of the stopper 176 is blocking the inlet 170, thereby sealing the storage chamber 110 from the valve chamber 152 and preventing a liquid from passing from the storage chamber 110 into the valve chamber 152. For example, when the buoyant float valve 154 is in the highest position, the proximal portion 175 is disposed within the inlet 170. The diameter of the proximal portion 175 is approximately similar to the diameter of inlet 170, or the tapered shaped of the stopper 176 is pressed against the tapered extrusion 172, or a combination of the two, such that a liquid is prevented from entering the valve chamber 152.

The stopper 176 is sized and shaped such that, in either the highest or lowest positions, at least a portion of the stopper 176 is disposed within the inlet 170. In some example embodiments, a portion of the inlet 170 or top portion 160 may press against the stopper 176, keeping the stopper 176 in a substantially upright position. Alternatively, or additionally, stopper 176 and inlet 170 may include other or additional features that ensure clearance between the stopper 176 and inlet 170 when the buoyant float valve 154 is in the lowest position. Likewise, stopper 176 and inlet 170 may include other or additional features that ensure sealing between storage chamber 110 and the valve chamber 152 when the buoyant float valve 154 is in the highest position.

In this illustrated embodiment, the valve chamber 152 is further in flow communication with the annular drinking trough 114. One or more of passages 180 (shown in FIG. 3) connect the valve chamber 152 with the annular drinking trough 114, allowing a liquid to flow from within the valve chamber 152 and into the annular drinking trough 114. In the embodiments shown in FIG. 1-3, the passages 180 may include a first passage 180 and a second passage (not shown) extending between valve chamber and the annular drinking trough 114.

Referring to FIG. 3, the supply container 100 further includes a first flange 182 and a second flange (not shown) that extend from the annular wall 158 of the valve container 150 to the annular wall 112 of the reservoir 102. The sizes and shapes of the first flange 182 and the second flange are such that the first flange 182 and the second flange do not take up a significant volume of the storage chamber 110. In other example embodiments, the first flange 182 and second flange may be any shape or size allowing the first flange 182 or the second flange to extend between the valve container 150 and the annular wall 112.

The first passage 180 is formed through the first flange 182 and the second passage is formed through the second flange. The first passage 180 and the second passage extend between the valve chamber 152 and the annular drinking trough 114.

The first flange 182 includes a first exit port 184 located on the annular wall 158 opening into the first passage 180. The first passage 180 leads to a first outlet 186 on the annular wall 112 opening into the annular drinking trough 114. As such, liquid contained in the valve chamber 152 flows out of the first exit port 184, through the first passage 180, out of the first outlet 186, and into the annular drinking trough 114. The first passage 180 is sized and shaped to extend the first passage 180 from the lower edge 159 of the valve chamber 152 to a height of h₁₈₀. Further, the first exit port 184 and the first outlet 186 have a height similar to the height of h₁₈₀ of the first passage 180.

The second flange includes a second exit port located on the annular wall 158 opening into the second passage. The second passage leads to a second outlet on the annular wall 112 opens into the annular drinking trough 114. Liquid contained in the valve chamber 152 flows out of the second exit port, through the second passage, out of the second outlet, and into the annular drinking trough 114. The second passage is sized and shaped to extend second passage from the lower edge 159 of the valve chamber 152 to a second passage height. Further, the second exit port and the second outlet have a height similar to the second passage height.

In this illustrated embodiment, the height of the first passage 180 is greater than the height of the second passage. In alternative embodiments, the first passage 180 and the second passage may be of any size or shape that allows a liquid to flow from within the valve chamber 152 and into the annular drinking trough 114.

In other example embodiments, the supply container 100 may include additional or alternative passages that enable the supply container 100 to function as described herein.

In this illustrated embodiment, the base mesh 162 includes a thickness t₁₆₂ that is slightly less than the height of the second passage. As such, water may pass through a clearance between the base mesh 162 and the valve chamber 152 through the second exit port, through the second passage, and out of the second outlet. Further, the base mesh 162 may limit the back flow of debris from the annular drinking trough 114 into the valve chamber 152 by blocking debris that has settled in the base 106 near either the first passage 180 or the second passage. In other words, the base mesh 162 may act as a filter.

The heated water supply container 100 as described in the present disclosure is reusable and includes features that readily enable a user to refill the storage chamber 110 and control the flow of water to the annular drinking trough 114. For example, during a refilling operation, a user may readily remove the lid 116 to expose the storage chamber 110 of the reservoir 102 for refilling. As the storage chamber 110 is being refilled, the water level within the storage chamber 110 rises. When the water level within the storage chamber 110 reach a height above the height h₁₁₀, water may flow from within the storage chamber 110, though the inlet 170, and into the valve chamber 152.

As the valve chamber 152 begins to fill with water in the clearance volume around the buoyant float valve 154, water begins to exit the valve chamber 152 through the first exit port 184 and flow through the passage 180. The water flows through the passage 180, exits through the first outlet 186, and into the annular drinking trough 114, filling the annular drinking trough 114.

As the water fills in the valve chamber 152, the buoyant float valve 154 begins to float and rise. As such, the stopper 176 also rises upward, forcing the stopper 176 into sealing engagement with the inlet 170. When the stopper 176 completely blocks the inlet 170, water is prevented from flowing from the storage chamber 110 into the valve chamber 152, thereby preventing overflow of the annular drinking trough 114.

Referring to FIG. 1, as animals begin to consume the water in the annular drinking trough 114, the fluid level begins to lower in the annular drinking trough 114. Water is subsequently drawn out of the valve chamber 152 through passage 180. This lowers the water level in the valve chamber 152, and the buoyant float valve 154 descends. As the buoyant float valve 154 descends, at least a portion of the stopper 176 is at least partially disposed within the inlet 170; however, there is clearance between the stopper 176 and the inlet 170, allowing the water to flow from the storage chamber 110 of the reservoir 102 into valve chamber 152. Accordingly, water filling the valve chamber 152 exits through the first exit port 184, flows through the passage 180, flows out of the first outlet 186, and into the annular drinking trough 114.

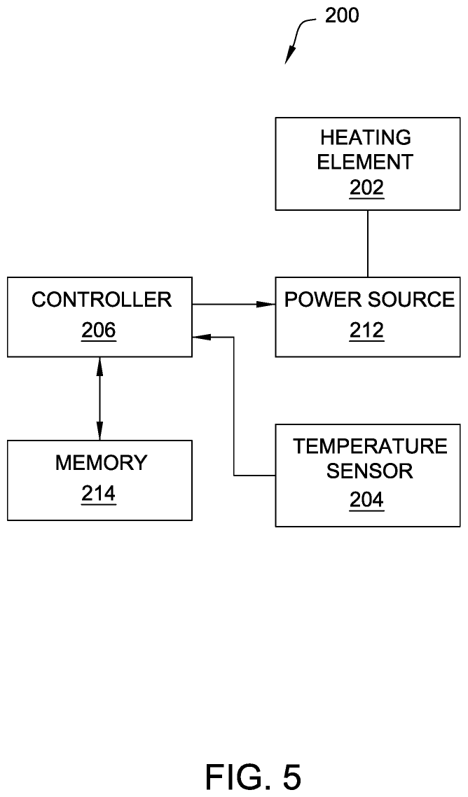

In embodiments illustrated in FIGS. 1-5, the water supply container 100 further includes a heating system 200 used to control or adjust the temperature of a liquid contained in the supply container 100. The heating system 200 may be used to supply thermal energy to the water within the annular drinking trough 114 and in the storage chamber 110.

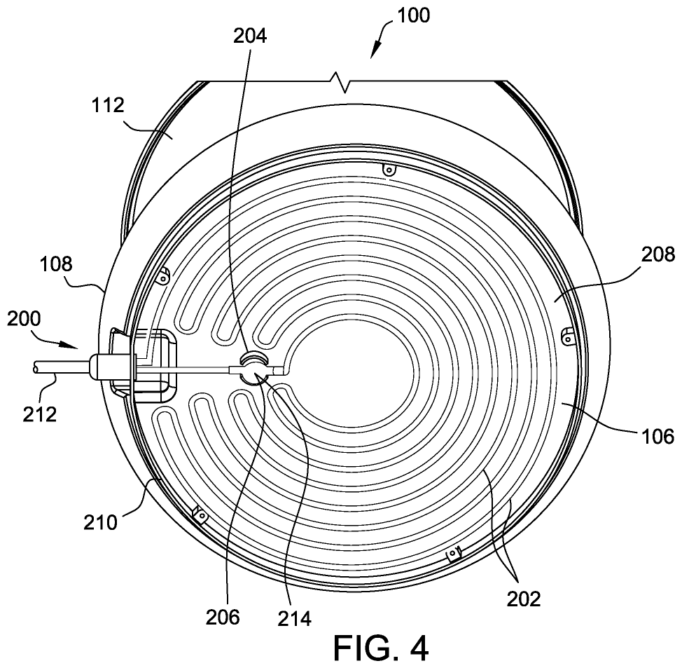

Referring to FIGS. 3 and 4, the heating system 200 includes a heating element 202, a temperature sensor 204, and a controller 206. The heating element 202 is coupled to the base 106 and extends along the base 106 opposite the annular drinking trough 114. The heating element 202 is arranged in proximity to a bottom surface 208 of the base 106 of the basin 104. In this illustrated embodiment, the heating element 202 is mounted to the bottom surface 208. The heating element 202 is arranged to enable the heating element 202 to heat the entire bottom surface 208 of the base 106. In the embodiment illustrated in FIGS. 3-4, the heating element 202 is arranged in a circular serpentine pattern on the bottom surface 208. Additionally, or alternatively, the heating element 202 may be arranged in other or different patterns on the base 106. Generally, heating element 202 is configured in any manner to produce sufficient heat to keep the water within the annular drinking trough 114, the valve chamber 152, and the storage chamber 110 in liquid form.

In some example embodiments, the bottom surface 208 of the base 106 may be coated or covered, in a metallic material, for example and without limitation, foil sheets. This metallic material may conduct the thermal energy generated by the heating elements 202 to enable uniform heating of the base 106. Further, the metallic material shields excessive heating in localized areas surrounding the heating element 202 by dispersing the thermal energy more evenly or uniformly. Additionally, or alternatively, the base 106 may be formed of a heat-conductive material.

As described herein, at least a portion of the base 106 acts as a boundary to the annular drinking trough 114 and to the valve chamber 152. The thermal energy emitted by the heating element 202 in proximity to the bottom surface 208 is transmitted through the base 106 and to the liquid contained in both the annular drinking trough 114 and the valve chamber 152. Maintaining the temperature of the liquid in the valve chamber 152 is of particular importance, as ice formation and/or complete freezing of the liquid in the valve chamber 152 will affect the performance of the buoyant float valve 154. More specifically, thermal energy generated by the heating element 202 passes through a first thickness of the base and substantially transmit heat to the liquid contained in the valve chamber 152 and the annular drinking trough 114.

Further, the annular base 156 of the reservoir 102 is in direct contact or is coupled to the base 106. Accordingly, thermal energy emitted by the heating element 202 is transmitted through the first thickness of the base 106 and through a second thickness of the annular base 156 to heat the liquid contained in the storage chamber 110. In some other example embodiments, the annular base 156 may be formed by at least a portion of base 106. Accordingly, heat generated by the heating element 202 may only need to pass through the first thickness of the base 106.

The basin 104 may include a lower wall 210 that extends downward from the bottom surface 208 of the base 106. The, the height of the lower wall 210 creates a clearance between the heating element 202 and the ground.

The temperature sensor 204 is used to monitor the temperature of a liquid contained in the supply container 100. In the embodiments shown in FIG. 1-5, the temperature sensor is positioned beneath the base 106 opposite the reservoir 102.

In some example embodiments, the temperature sensor 204 is mounted to the annular wall 112 to enable submersion of the temperature sensor 204 in the liquid contained in the storage chamber 110. The temperature sensor 204 may be mounted substantially close to the bottom of the annular wall 112 or mounted to the annular base 156, to ensure the temperature sensor 204 measures the temperature of the liquid, even when liquid levels are relatively low.

In other example embodiments, temperature sensor 204 may be placed in various locations within the water supply container 100.

In other example embodiments, one or more temperature sensors 204 may be positioned to measure the temperature in one or more of the valve chamber 152 or the annular drinking trough 114. Furthermore, as shown in FIG. 4, the temperature sensor 204 may be incorporated into the controller 206 and positioned beneath base 106 where temperature sensor 204 can measure either or both of the liquid temperature in the valve chamber 152 or the ambient air temperature, and controller 206 controls the heating element 202 accordingly. Generally, the temperature sensor 204 is positioned in any location that enables operation of heating system 200 as described herein.

A power source 212 supplies power to the heating element 202. The power source 212 may include any suitable power source such as a battery power or AC or DC power connection. When the power source 212 supplies power to the heating element 202, the heating element 202 emits thermal energy.

The controller 206 (also referred to as a thermostat) is communicatively connected with the temperature sensor 204 and the power source 212. The controller 206 may receive and transmit a plurality of signals to and from the temperature sensor 204 and the power source 212. In this illustrated embodiment, the controller 206 is mounted to the base 106 or the lower wall 210.

The controller 206 may receive a signal transmitted by the temperature sensor 204 and the controller 206 may determine a current temperature of the water contained within the water supply container 100 based on this signal.

Further, the controller 206 may transmit a signal to the power source 212, in order to adjust the power supplied to the heating element 202. For example, the controller 206 may transmit a signal to the power source 212 to cause the power source 212 to turn on or off. In some example embodiments, the controller 206 may selectively increase or decrease the power supplied (e.g., the voltage or current supplied) to the heating element 202. As such, the controller 206 may adjust the amount of heat supplied to the water by the heating element 202.

Additionally, the controller 206 may adjust the power supplied to the heating element 202 based on signals received from the temperature sensor 204. In some example embodiments, the controller 206 may be communicatively coupled to a memory 214. In other example embodiments, the memory 214 may be integrated with the controller 206. The memory 214 may store one or more values associated with the monitored temperature of the water. In some illustrated embodiments, the memory 214 stores a threshold temperature value. The controller 206 may compare the current temperature value, based on signals received from the temperature sensor 204, to the threshold temperature value stored in the memory 214. If the current temperature falls below the threshold temperature, then then the controller 206 may increase the power supplied to the heating element 202.

In some embodiments, the threshold temperature may be in the range of −2° C. to 10° C. (28° F. to 50° F.). If the current temperature falls below the threshold, then the controller 206 may turn on the power supplied to the heating element 202. Additionally or alternately, the controller 206 may increase the power supplied to the heating element 202, to increase the temperature of the water within the water supply container 100.

Further, if the current temperature exceeds the threshold value, then the controller may transmit a signal to the power source 212 to shut off the power supplied to the heating element 202. Additionally or alternatively, the controller 206 may decrease the power supplied to the heating element 202. The memory 214 may store one or more threshold values, for example and without limitation, an upper threshold value and a lower threshold value.

In some example embodiments, the power supplied to the heating element 202 may be shut off or turned on by a user switch. As such, a user may selective shut off or supply power to the heating element 202.

As used herein, the terms “about,” “substantially,” “essentially,” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawings shall be interpreted as illustrative and not in a limiting sense.

1. An animal water supply container, the water supply container comprising:
a reservoir comprising an annular wall that defines a reservoir chamber;
a basin coupled to the reservoir, the basin comprising:
a base positioned beneath and coupled to the reservoir; and
an outer wall extending from the base, wherein the outer wall, the annular wall, and the base define a trough configured to retain water, wherein the base is between the outer wall and the annular wall; and
a heating system coupled to the base and configured to transmit thermal energy to water within trough and reservoir chamber.

2. The water supply container in accordance with claim 1, wherein the heating system comprises a heating element coupled to the base and extending along the base opposite the trough.

3. The water supply container in accordance with claim 2, wherein the heating system comprises a temperature sensor positioned beneath the base opposite the reservoir.

4. The water supply container in accordance with claim 3, wherein the heating system comprises a controller coupled to the temperature sensor and to the heating element and positioned beneath the base opposite the reservoir.

5. The water supply container in accordance with claim 4, wherein the temperature sensor and the controller are combined together in a single component.

6. The water supply container in accordance with claim 1, wherein the reservoir comprises a valve container that defines a valve chamber, the valve chamber coupled in flow communication with the reservoir chamber via an inlet defined in the valve container.

7. The water supply container in accordance with claim 6, wherein the reservoir comprises a float valve positioned with the valve chamber, wherein the float valve is configured to selectively seal the inlet to control a flow of water from the reservoir chamber to the valve chamber.

8. The water supply container in accordance with claim 7, wherein the float valve comprises a stopper configured to seal the inlet when the float valve is in a first position, and wherein the stopper is configured to allow the flow of water into the valve chamber when the float valve is in a second position.

9. The water supply container in accordance with claim 8, wherein the first position is associated with a first water level in the valve chamber, and wherein the second position is associated with a second water level within the valve chamber that is lower than the first water level.

10. The water supply container in accordance with claim 8, wherein the reservoir further comprises at least one passage extending between the valve container and the trough through the annular wall, wherein the passage couples the valve chamber in flow communication with the trough.

11. The water supply container in accordance with claim 10, further comprising a filter positioned between the passage and the valve chamber to prevent debris from entering the valve chamber.

12. The water supply container in accordance with claim 1, wherein the reservoir is removably coupled to the basin.

13. The water supply container in accordance with claim 1, wherein the reservoir comprises a top-fill reservoir.

14. The water supply container in accordance with claim 1, further comprising a lid removably coupled to the reservoir.

15. An animal water supply container, the water supply container including:
a reservoir comprising:
an annular wall that defines a reservoir chamber; and
a valve container that defines a valve chamber, the valve chamber coupled in flow communication with the reservoir chamber via an inlet defined in the valve container;
a basin coupled to the reservoir, the basin comprising:
a base positioned beneath and coupled to the reservoir; and
an outer wall extending from the base, wherein the outer wall, the annular wall, and the base define a trough configured to retain water, wherein the reservoir further comprises at least one passage extending between the valve container and the trough through the annular wall, wherein the passage couples the valve chamber in flow communication with the trough.

16. The water supply container in accordance with claim 15, wherein the reservoir comprises a float valve positioned with the valve chamber, wherein the float valve is configured to selectively seal the inlet to control a flow of water from the reservoir chamber to the valve chamber.

17. The water supply container in accordance with claim 16, wherein the float valve comprises a stopper configured to seal the inlet when the float valve is in a first position, and wherein the stopper is configured to allow the flow of water into the valve chamber when the float valve is in a second position, wherein the first position is associated with a first water level in the valve chamber, and wherein the second position is associated with a second water level within the valve chamber that is lower than the first water level.

18. The water supply container in accordance with claim 15, further comprising a lid removably coupled to the reservoir, wherein the reservoir comprises a top-fill reservoir.

19. The water supply container in accordance with claim 15, further comprising a heating system coupled to the base and configured to transmit thermal energy to water within trough and reservoir chamber.

20. The water supply container in accordance with claim 19, wherein the heating system comprises a heating element coupled to the base and extending along the base opposite the trough.
